(19) United States
(12) Patent Application Publication
(10) Pub. No.: US 2012/0093292 A1
(43) Pub. Date: Apr. 19, 2012

(54) X-RAY TUBE WITH ADJUSTABLE FOCAL TRACK

(75) Inventors: Kevin Kraft, Plainfield, IL (US); Gerald James Carlson, Aurora, IL (US); Mark Maska, Aurora, IL (US); Paul Xu, Oswego, IL (US)

(73) Assignee: KONINKLIJKE PHILIPS ELECTRONICS N.V., EINDHOVEN (NL)

(21) Appl. No.: 13/376,519

(22) PCT Filed: Jun. 28, 2010
(86) PCT No.: PCT/IB10/52932

§ 371 Date: Dec. 6, 2011

Related U.S. Application Data
(60) Provisional application No. 61/221,185, filed on Jun. 29, 2009.

(51) Int. Cl. H01J 35/10; G01N 23/04

(52) U.S. Cl. 378/62; 378/125

(57) ABSTRACT

The invention relates to an X-ray tube with a rotatable anode, an X-ray imaging system and a method for adjusting the focal track of an X-ray tube with a rotatable anode. In order to improve the accuracy of X-ray tubes with rotating anodes and the run out characteristics of rotatable anodes, an X-ray tube with an envelope housing a cathode and an anode assembly is provided, wherein the anode assembly comprises a rotatable disk provided with an annular target forming a focal track, which focal track is rotationally symmetric around a symmetry axis, and a rotor stem for supporting the disk, which stem is rotatably supported around a primary axis of rotation. The stem is provided with a mounting surface to support the disk and the disk is provided with an abutment surface to be mounted to the mounting surface. According to the invention, correction means are arranged between the mounting surface and the abutment surface such that a run-out of the focal track in relation to the axis of rotation is adjustable.

### FIELD OF THE INVENTION

The invention relates to an X-ray tube with a rotatable anode, an X-ray imaging system and a method for adjusting the focal track of an X-ray tube with a rotatable anode.

### BACKGROUND OF THE INVENTION

Rotating anodes for X-ray tubes are made of refractory materials which must comply with tight specification of lateral and radial movement. This lateral and radial movement is controlled by the anode systems run out specification. The run out of the focal track must be controlled to ensure imaging stability, imaging quality, limited mechanical vibration, tube life etc. U.S. Pat. No. 7,184,520 B1 shows an anode plate with a nut provided with a tapered contour to be received in a tapered recess thereby centering the anode. But it has shown that fabricated anodes sometimes show run out variations beyond the range of tolerance which is continuously decreasing, for example, due to increasing accuracy requirements.

### SUMMARY OF THE INVENTION

Hence, there may be a need to improve the accuracy of X-ray tubes with rotating anodes and the run out characteristics of rotatable anodes.

According to an exemplary embodiment of the invention, an X-ray tube with an envelope housing, a cathode and an anode assembly is provided, wherein the anode assembly comprises a rotatable disk provided with an annular target forming a focal track. The focal track is rotationally symmetric around a symmetry axis. A rotor stem for supporting the disk is provided which stem is rotatably supported around a primary axis of rotation. The stem is provided with a mounting surface to support the disk and the disk is provided with an abutment surface to be mounted to the mounting surface. Correction means are arranged between the mounting surface and the abutment surface such that a run out of the focal track in relation to the axis of rotation is adjustable.

The correction means provide the advantage that an adjustment of the run out of the focal track in relation to the axis of rotation is possible subsequent to the fabrication of the anode disk. For example, the disk can be provided by a supplier with a certain degree of tolerance regarding the run out, and the final adjustment of the run out of the focal track can be arranged prior to the assembly mounting the rotatable disk to the rotor stem.

Further, it is also possible to provide one type of a rotatable disk with a larger range of tolerance which can be used for different types of X-ray tubes with different tolerance requirements. This has the advantage that the production of the rotatable disk is facilitated which leads to economic benefits. By providing one type of rotatable disk for different types of X-ray tubes, also handling and storage is facilitated. In case the disk with a rather large range of tolerance concerning the run out of the focal track is used for an X-ray tube with precise requirements concerning the run out of the focal track the precision requirement is provided by the correction means.

In an exemplary embodiment the focal track is cylindrically symmetric. For example, the focal track consisting of an annular target is applied to a matrix material arranged for dissipating the heat from the annular target.

In an exemplary embodiment, the focal track is n-fold rotationally symmetric which can also be defined as a discrete rotatable symmetry of the n-th order. For example, this may be the case with a meandering annular target provided with such an amplitude that due to the width of the target a straight linear annular target line is still provided. In other words, the electron beam from the cathode hitting the anode at the same position in relation to the axis of rotation hits the annular target during the rotation both in the middle of the annular target and at either side portions of the annular target which may provide improved heat dissipation from the annular target, for example.

In an exemplary embodiment the disk is made of a substrate material. The substrate material can be chosen to optimize the aspects of mechanical properties as well as heat dissipation.

In an exemplary embodiment the substrate material is carbon-fibre reinforced carbon (CFC) composite.

Such a substrate material provides favourable properties concerning high temperature, high strength and good thermal conductivity as well as heat capacity. The concept of CFC composite rotating anodes creates an opportunity to customize the matrix to maximize the mechanical strength of the substrate material which provides advantages for rotating anodes in X-ray devices that are subjected to large mechanical stresses from the anode rotation and gantry rotation as well. For example, to optimize hoop, i.e. tangential and radial mechanical properties, the CFC can be woven in a polar configuration to provide true radial and circumferential fibres creating rotational symmetry. However, the surface condition and inability to perform position machining on such a substrate is overcome by providing the correction means according to the invention.

CFC anodes have improved characteristics, for example, for the purpose of high-end, high-power, fast rotation speed, and large power density CT systems of the future. As the power demand increases and the focal spot size decreases, the CFC anode provides advantages in dealing with mechanical and thermal-mechanical stresses, as well as withstanding and dealing with the thermal loads of high-end CT systems.

In an exemplary embodiment the correction means are arranged such that a deviation between the symmetry axis and the primary axis of a rotation is at least partially compensated.

This provides the possibility to adjust the run out of the focal track to a designated tolerance spectrum.

In an exemplary embodiment the correction means compensate a radial offset of the symmetry axis in relation to the primary axis of rotation.

This provides the advantage that a centering of the anode disk is arranged in dependency from the actual position of the focal track on the rotatable disk. In other words, the centering is arranged in relation to the focal track and not in relation to the abutment surface of the disk itself.

In an exemplary embodiment the correction means compensate an inclination of the symmetry axis in relation to the primary axis of rotation.

Thereby it is possible to minimize or even to eliminate a so-called wobbling of the disk which not only leads to a run out of the focal track but which also leads to undesired vibrations which mean an unnecessary burden to the bearings of the rotor stem.

In an exemplary embodiment the mounting surface is perpendicular to the primary axis of rotation and the correction means compensate an inclination of the abutment surface in relation to the perpendicular of the symmetry axis.

Because the requirements for the rotor stem are different to those of the anode disk, i.e. slightly lower refractory characteristics, for example, the rotor stem can be made of a material with mechanical properties suitable to perform precision machining. Hence, the mounting surface can be provided with a very high precision. The correction means are thus provided to balance the inaccuracy of the abutment surface. Simply said, the correction means align the perpendicularity of the abutment surface and the mounting surface respectively in relation to the primary axis of rotation.

In an exemplary embodiment the correction means comprise at least one correction shim with a varying thickness providing two outer support surfaces inclined in relation to each other.

This provides the advantage that correction shims can be provided with different inclinations of the two outer support surfaces such that the correct inclination value can be chosen to adjust the run out of the focal track to the desired value. The correction shims can be provided in a material suitable for high precision machining which also provides cost reductions since the correction shims are rather small parts to which high precision requirements comply.

In an exemplary embodiment two correction shims are provided of which at least one has a varying thickness.

It is thus possible to provide for a correction or adjustment of the position of the focal track in relation to the axis of rotation. For example, the inclination can be provided by one correction shim whereas the adjustment in the direction of the axis of rotation can be provided the second correction shim which has parallel support surfaces but a different thickness. Providing two correction shims also has the advantage that different inclination values can be provided by two correction shims with the same inclination value.

In an exemplary embodiment the correction means are provided with an offset centre.

Thereby it is also possible to adjust a radial offset of the symmetry axis in relation to the primary axis of rotation.

In an exemplary embodiment the correction means comprise a precision machinable bushing to be affixed to the abutment surface and the bushing is provided with a fitting surface abutting the mounting surface.

The contact between the mounting surface and the abutment surface provides for translating movement forces from the stem to the disk and stability, i.e. fixation and transfer of weight loads, of the disk. The fitting surface transfers the forces and loads to and from the disk via the bushing.

For example, the bushing is provided the fitting surface prior to fixation of the bushing to the disk. Thus, the fitting surface can be provided with high accuracy.

In another example, the bushing is affixed to the disk and the fitting surface is provided thereafter. Thus, any inaccuracy or tolerance due to the mounting procedure of the bushing to the disk can be eliminated during the provision of the fitting surface on the bushing itself.

In an exemplary embodiment the bushing is hexagonally shaped on the outside for translating rotational forces wherein the bushing is inserted into a hexagonally shaped recess provided in the disk.

Thereby it is possible to translate the rotational movement from the stem to the disk without the necessity to clamp the disk for example. This form of translating the rotational forces is especially suitable for rotatable disks rotated in a very high speed.

In an exemplary embodiment at least one correction shim is provided between the fitting surface of the bushing and the mounting surface of the stem.

This provides the advantage that the bushing can be affixed to the disk and any resulting inaccuracy which otherwise might lead to a run out of the focal track can be compensated by the at least one correction shim. As mentioned above, the correction shim can be made of a suitable material to be machined or otherwise arranged to the grade of precision necessary for the accuracy required.

In an exemplary embodiment the recess in the disk is a through-hole and the stem is provided with a threaded end extending through the bushing, wherein a nut is screwed onto the threaded end such that the abutment surface of the anode is pressed against a countersurface of the bushing. Thereby a contact of the fitting surface of the bushing with the mounting surface of a stem is provided.

Thus, it is possible to translate the rotational movement via the hexagonally shaped bushing and recess respectively whereas the nut screwed onto the end of the stem provides a secure hold of the disk necessary to withstand the forces appearing during a rotation of the gantry, for example.

In an exemplary embodiment, the corrections means is made from a refractory metal. For example, the corrections means is made from Niobium. In an exemplary embodiment, a shim is used made from Niobium. This provides the advantage of providing ductility in the joint. In further embodiments, other specific types of refractory metal can also be used to provide ductility in the joint.

In an exemplary embodiment, the Niobium shim is provided as a ductile washer.

Thereby it is possible to apply a spring force to the assembly, i.e. to the anode, without applying to great a stress to the disk material.

For example, this is suitable with CFC used for the disk.

According to an exemplary embodiment, a Niobium shim is provided that diffuses to the stem in case the stem is made from TZM (Molybdenum-alloy), because Niobium and Molybdenum (a major element in TZM) can have mutual diffusion. Further, Niobium in the correction means and Carbon (in CFC) in the disk can create NbC (Niobium Carbide). This ultimately bonds the TZM rotor stem to the CFC target thru the Niobium washer. For example, the bonding process occurs at processing and operating temperatures.

These bonds will ensure a good contact and no slip at the joint interface.

In an exemplary embodiment, the shim material is selected accounting for dissimilar thermal expansions in the bolt connection.

As the temperature rises in application, the CFC, for example, will expand more than the TZM stem/nut, so the ductile shim will comply with the stresses and better match the total systems thermal expansion.

In an exemplary embodiment, the run out of the focal track is eliminated.

According to a further aspect of the invention, an X-ray imaging system is provided that comprises an X-ray image acquisition device with a source of X-ray radiation to generate X-ray radiation. Further, an X-ray image detection module is provided. A data processing unit is connected to the detection module and a radiation source. A display device and an interface unit are provided. Furthermore, the source of X-ray radiation comprises an X-ray tube according to one of the preceding exemplary embodiments.

Thus, an X-ray imaging system is provided with focal track characteristics that comply with very precise run out specifications to ensure that the focal spot is in the same location during the application to provide X-ray imaging with a quality as high as required.

According to an exemplary embodiment, a device to receive a subject is provided between the source of X-ray radiation and the X-ray image detection module. For example, the device can be provided as a table in order to examine a patient.

According to another exemplary embodiment, the device is a stand for chest X-ray systems such as for breast cancer investigations.

According to another exemplary embodiment, the device is a device for receiving items such as baggage, for example for security checks, or other industrial applications. Of course, it is possible to provide a system without a display device and an interface unit for cases where the data is transferred and/or stored at other locations.

According to another aspect, an X-ray device is provided with a source of X-ray radiation wherein the source of X-ray radiation comprises an X-ray tube according to one of the above discussed exemplary embodiments. For example, this can be used for applying X-rays in industrial processes where objects are radiated but not imaged, hence without detector modules or the like.

According to another aspect, a method for adjusting the focal track of an X-ray tube according to one of the above-described embodiments is provided that comprises the following steps. First, the magnitude for the run out of the focal track in relation to the rotation axis is determined. Then, the actual value of the run out of the focal track of the X-ray tube is detected. Further, the actual value is compared with a determined value and the correction means are adapted thereby adjusting the run out of the focal track to the determined value.

In an exemplary embodiment, for adapting the correction means, a bore is provided in a bushing to be inserted into the anode disk. The drilling of the bore provides for an alignment of the symmetry axis and the rotation axis.

In an exemplary embodiment the adapting step includes the determination of the varying thickness and the inclination of the outer support surfaces of at least one correction shim and the rotatable adjustment of the at least one correction shim to compensate for an inclination of the abutment surface in relation to the perpendicular of the symmetry axis, in case the mounting surface is perpendicular to the primary axis of rotation.

Magnitude for the run out of the focal track may comprise a threshold. In a further exemplary embodiment, the magnitude may comprise setting a range for the run out of the focal track.

### BRIEF DESCRIPTION OF THE DRAWINGS

These and other aspects of the invention will be apparent from the exemplary embodiments described hereinafter with reference to the drawings.

FIG. 1 schematically shows an X-ray imaging system with an X-ray tube with a rotatable anode;

FIG. 2 schematically shows an anode assembly in a cross-sectional view;

FIG. 3 shows an anode assembly in a perspective exploded view;

FIG. 4 shows the anode assembly of FIG. 2 in an exploded cross-sectional view;

FIG. 5 shows the anode assembly of FIG. 2 in a mounted state in a perspective cross-sectional view;

FIG. 6 shows the anode assembly of FIG. 4 in a cross-sectional view;

FIG. 7 shows a top view of an anode assembly; and

FIG. 8 schematically shows a flow-chart of a method for adjusting the focal track of an X-ray tube.

### DETAILED DESCRIPTION OF EXEMPLARY EMBODIMENTS

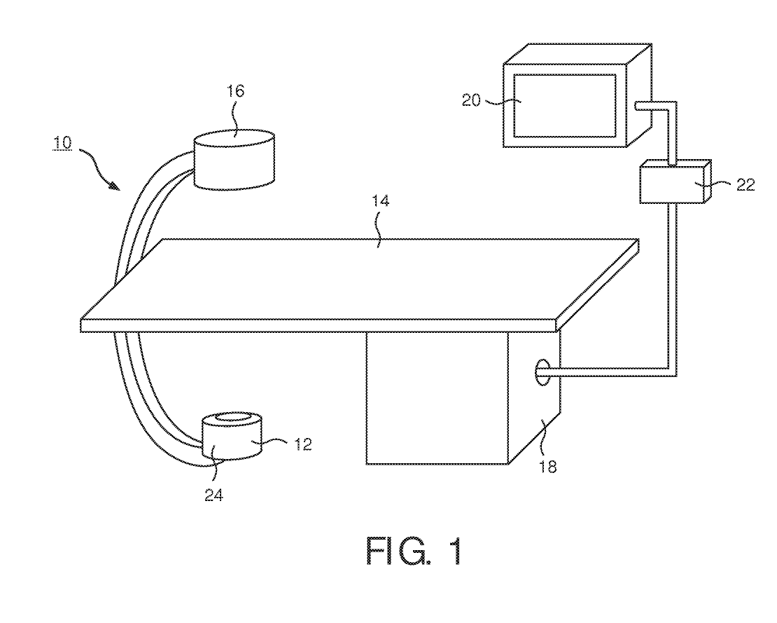

FIG. 1 schematically shows an X-ray imaging system 10 with an X-ray image acquisition device with a source of X-ray radiation 12 provided to generate X-ray radiation. A table 14 is provided to receive a subject to be examined. Further, an X-ray image detection module 16 is located opposite the source of X-ray radiation 12, i.e. during the radiation procedure the subject is located between the source of X-ray radiation 12 and the detection module 16. The latter is sending data to a data processing unit or calculation unit 18 which is connected to both the detection module 16 and the radiation source 12. The calculation unit 18 is located underneath the table 14 to save space within the examination room. Of course, it could also be located at a different place, such as a different room or laboratory. Furthermore, a display device 20 is arranged in the vicinity of the table 14 to display information to the person operating the X-ray imaging system, which can be a clinician. Preferably the display device 20 is movably mounted to allow for an individual adjustment depending on the examination situation. Also, an interface unit 22 is arranged to input information by the user. Basically the image detection module 16 generates images by exposing a subject to X-ray radiation, wherein said images are further processed in the data processing unit 18. It is noted that the example shown is of a so-called C-type X-ray image acquisition device. The X-ray image acquisition device comprises an arm in form of a C where the image detection module 16 is arranged at one end of the C-arm and the source of X-ray radiation 12 is located at the opposite end of the C-arm. The C-arm is movably mounted and can be rotated around the object of interest located on the table 14. In other words, it is possible to acquire images with different directions of view.

It must be noted that the table 14 is shown for illustrative purposes, for example to examine a patient.

In a further embodiment (not shown), an X-ray imaging system is provided with a device to receive a subject, wherein the device is arranged between the source of X-ray radiation and the X-ray image detection module. For example, the device can be a stand for chest X-ray systems such as for breast cancer investigations.

According to another exemplary embodiment (also not shown), the device is arranged for receiving items such as baggage, for example for security checks, or other industrial applications. Of course, it is possible to provide a system without a display device and an interface unit for cases where the data is transferred and/or stored at other locations.

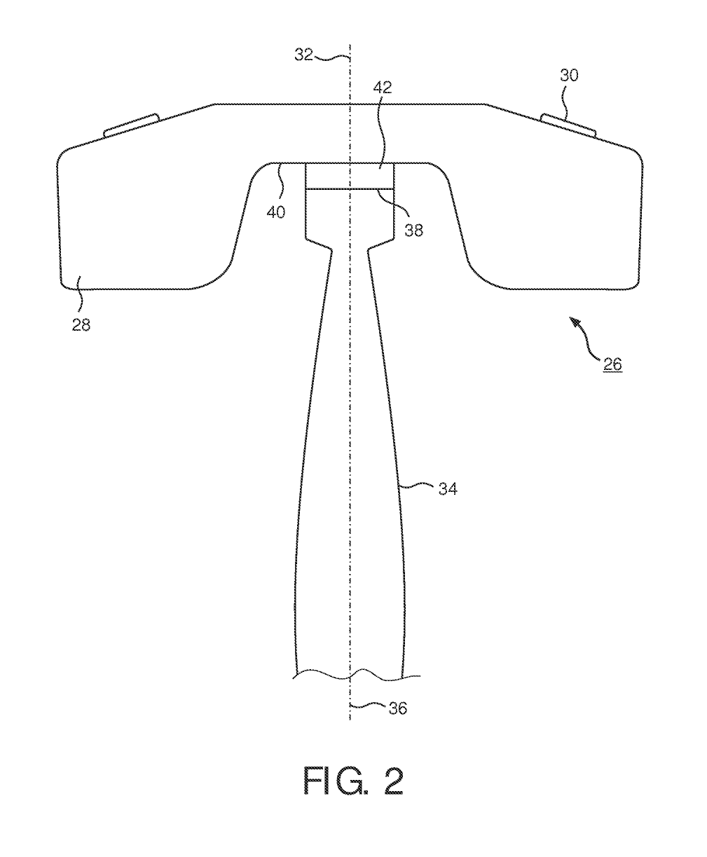

The source of X-ray radiation 12 in FIG. 1 comprises an X-ray tube 24 with an anode assembly 26 (schematically shown in FIG. 2) and an envelope housing and a cathode (both not shown in FIG. 2). The anode assembly 26 will be described in more detail in the following.

The anode assembly 26 comprises a rotatable disk 28 provided with an annular target 30 forming a focal track. The focal track 30 is rotationally symmetric around a symmetry axis 32. A rotor stem 34 is provided for supporting the disk 28. The stem 34 is rotatably supported around a primary axis of rotation 36. The stem 34 is provided with a mounting surface 38 to support the disk 28. The disk 28 is provided with an abutment surface 40 to be mounted to the mounting surface 38 of the stem. The contact of the mounting surface 38 and the abutting abutment surface provides the transfer of weight loads from the disk as well as rotational forces from the stem to the disk.

In order to provide an X-ray tube 24 with high quality imaging characteristics, correction means 42 are arranged between the mounting surface 40 and the abutment surface 38 such that a run out of the focal track 30 in relation to the axis of rotation 36 can be adjusted.

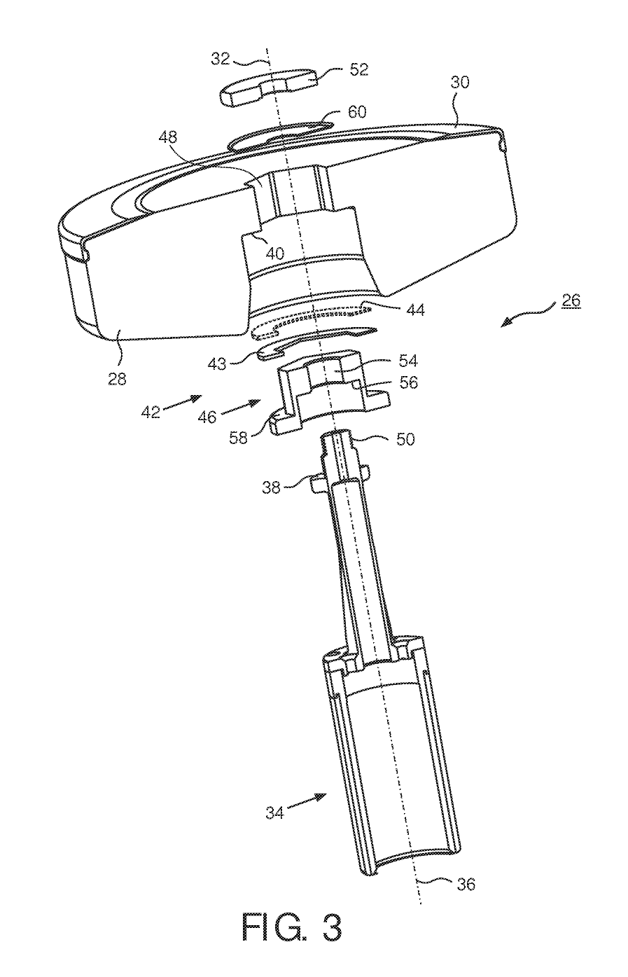

In FIG. 3 a further exemplary embodiment is shown where the mounting surface 38 is perpendicular to the primary axis of rotation 36 and wherein the correction means 42 compensate an inclination of the abutment surface 40 in relation to the perpendicular of the symmetry axis 32. The correction means comprise at least one correction shim with a varying thickness to provide two outer support surfaces inclined in relation to each other. In a further exemplary embodiment another correction shim 44 (see dashed lines) is provided which has a varying thickness, too. Thus, different inclination values can be achieved by simply rotating the shims 43 and 44 in relation to each other around the rotation axis 36.

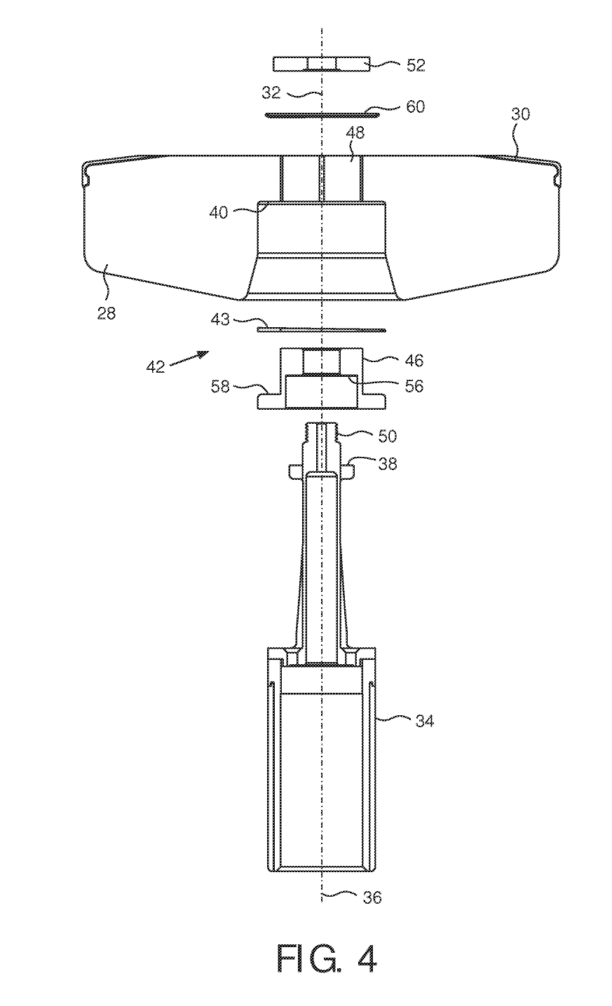

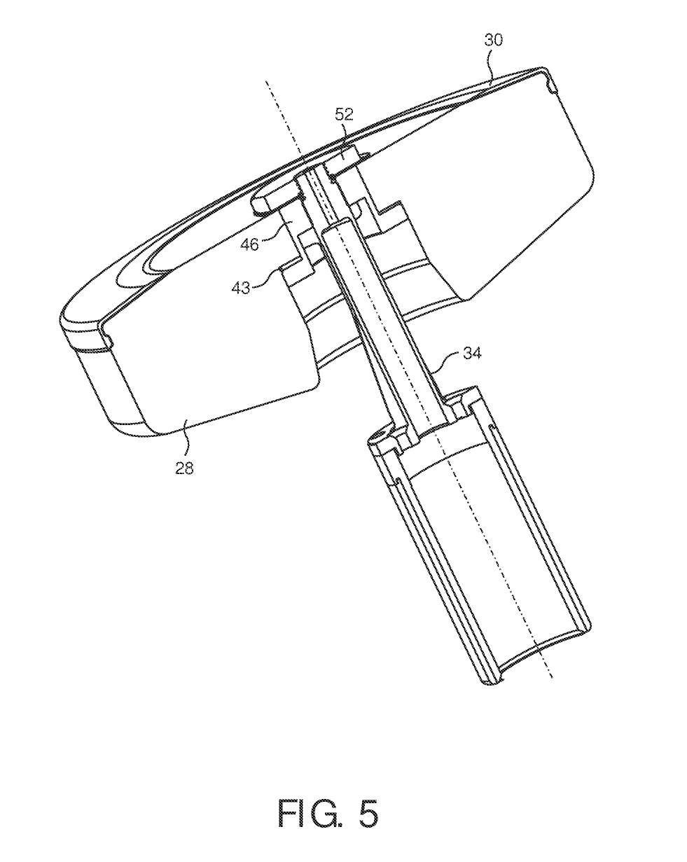

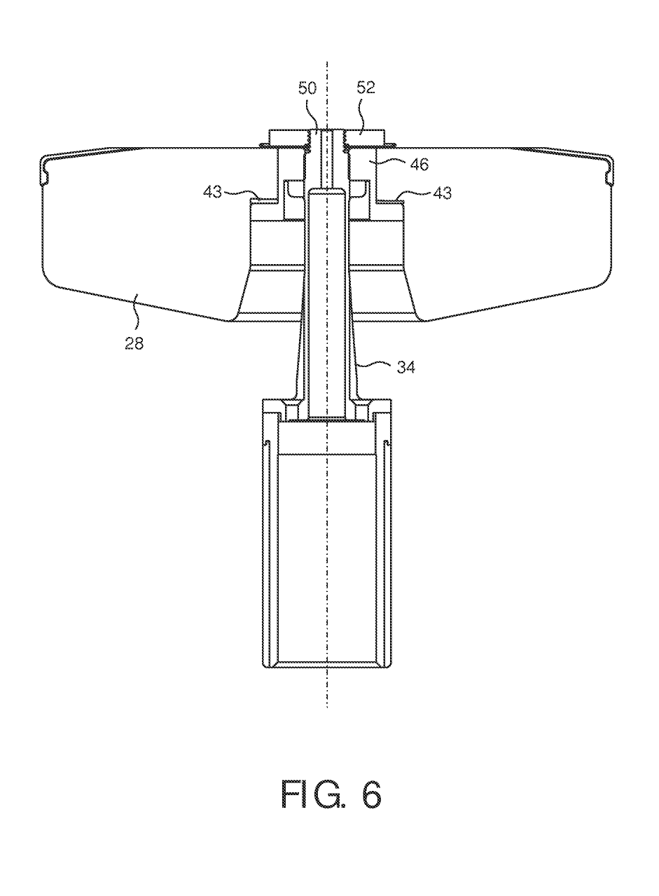

The correction means 42 further comprise a precision machinable bushing 46 to be affixed to the abutment surface 40. The bushing 46 is hexagonally shaped on the outside for translating rotation. As can be seen from FIGS. 4 to 6, the bushing 46 is inserted into a hexagonally shaped recess 48 provided in the disk 28. The recess 48 in the disk 28 is a through-hole and the stem 34 is provided with a threaded end 50 extending through the bushing 46 in the mounted state shown in FIGS. 4 and 5. A nut 52 is screwed onto the threaded end such that the disk 28 is affixed and securely hold to the stem 34.

The bushing 46 is provided with a through-hole 54 to allow the threaded end 50 of the stem 34 to extend through the bushing 46. Further, the bushing 46 is also provided with a fitting surface 56 to abut the mounting surface 38 of the stem 34 in the mounted state.

For example, the bushing is provided with the fitting surface 56 prior to fixation of the bushing 46 to the disk 28.

When the nut 52 is screwed onto the threaded end 50 the abutment surface 40 of the anode is pressed against a countersurface 58 provided at the outer side of the bushing 46, thereby providing contact of the fitting surface 56 of the bushing 46 with a mounting surface 38 of the stem 34.

For a secure hold, an additional shim 60 is provided between the nut 52 and the disk 28 and the bushing 46 respectively.

For an adjustment of the run out of the focal track, the correction shim 43 is provided with an inclined surface such that a deviation between the symmetry axis 32 and the primary axis of rotation 36 is at least partially compensated. In the examples shown, the adjustment by the correction means 42 is provided such that the run out of the focal track 30 is eliminated. In other words, the (corrected) symmetry axis 32 and the primary axis of rotation 36 have the same position and are thus indicated with the same line.

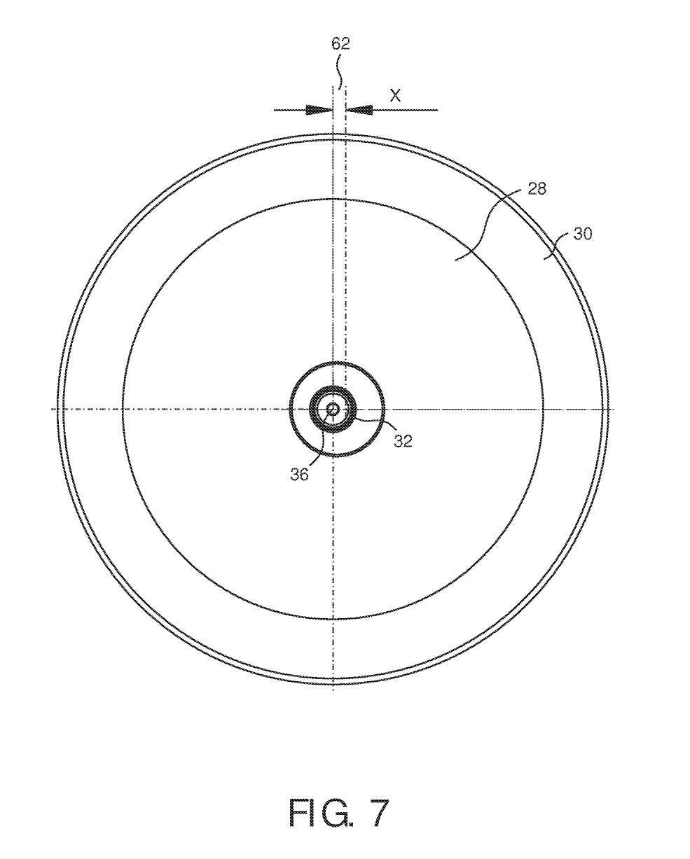

In order to compensate a radial offset 62 (x) of the symmetry axis 32 in relation to the primary axis of rotation 36, the correction means are provided with an offset centre (see FIG. 7). In order to align the axis of rotation 36 and the symmetry axis 32 the bushing 46 is provided with bores to achieve the through-hole 54 and the fitting surface 56 after determining the run out of the focal track 30 on the disk 28. In other words, the through-hole 54 and the fitting surface 56 are provided after the bushing 46 has been inserted into the disk 28.

For example, the disk 28 shown in FIGS. 2 to 7 is made of a substrate material, such as a carbon-fibre reinforced carbon (CFC) composite. This material creates the opportunity to customize the matrix of the disk 28 to maximize the mechanical strength of the substrate material. This anode assembly must maintain a tight run out specification to ensure the focal spot, i.e. the focal track 30, is in the same location due to the application for high quality imaging.

CFC anodes have improved characteristics, for example, for the purpose of high-end, high-power, fast rotation speed, and large power density CT systems of the future. As the power demand increases and the focal spot size decreases, the CFC anode provides advantages in dealing with mechanical and thermal-mechanical stresses, as well as withstanding and dealing with the thermal loads of high-end CT systems.

For example, to optimize hoop (or tangential) and radial mechanical properties, the CFC can be woven in a polar configuration to provide a true radial and circumferential fibres creating rotational symmetry. This anode assembly must maintain a tight run out specification to ensure the focal spot, i.e. the focal track 30, is in the same location due to the application for high quality imaging.

However, the surface condition and the inability to perform precision machining on such a substrate provide a disadvantage that is overcome by providing correction means to be arranged between the mounting surface and the abutment surface such that a run out of the focal track in relation to the axis of rotation is adjustable.

In the examplary embodiments shown, the corrections means is made from a refractory metal. For example, the corrections means can be made from Niobium. For example, the shim 43 that is used is made from Niobium to provide ductility in the joint. According to exemplary embodiments not shown, other specific types of refractory metal can also be used to provide ductility in the joint. In order to apply a spring force to the assembly, i.e. to the anode, without applying to great a stress to the disk material, the Niobium shim 43 is provided as a ductile washer. For example, this is suitable for cases where CFC is used for the disk.

The Niobium shim 43 diffuses to a TZM (Molybdenum-alloy) rotor stem and creates a Niobium Carbide bond to the CFC substrate at processing and operating temperatures. These bonds will ensure a good contact and no slip at the joint interface.

As the temperature rises in application, the CFC, for example, will expand more than the TZM stem/nut, so the ductile shim will comply with the stresses and better match the total systems thermal expansion.

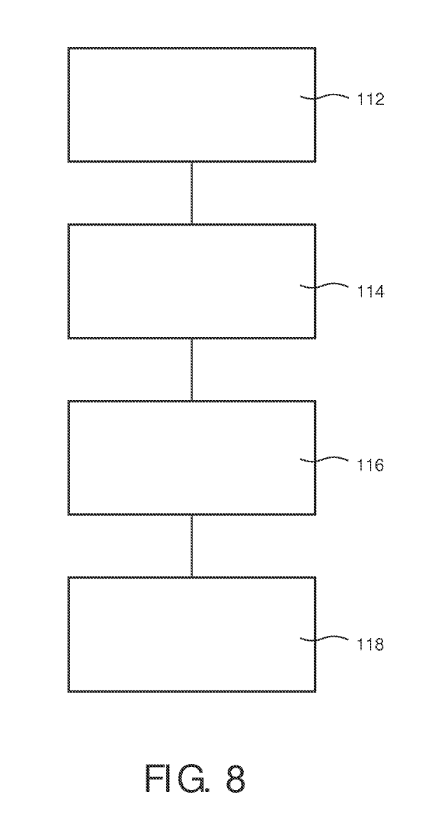

In FIG. 8, a method for adjusting the focal track of an X-ray tube according to the invention is schematically described with a flow-chart. The method comprises the steps of determining 112 the magnitude for the run out of the focal track 30 in relation to the rotation axis 36. For example, the magnitude can be a threshold or a range that is desired or required.

In the next step a detecting 114 of the actual value of the run out of the focal track 30 is performed. For example, this can be achieved by testing or analyzing the geometric circumstances of the present anode 28 and the focal track 30.

The next step 116 comprises comparing the actual value with the determined value.

In a further step 118, the correction means 49 are adapted thereby adjusting the run out of the focal track 30.

While the invention has been illustrated and described in detail in the drawings and foregoing description, such illustration and description are to be considered illustrative or exemplary and not restrictive; the invention is not limited to the disclosed embodiments.

1. X-ray tube with an envelope housing a cathode and an anode assembly; wherein the anode assembly comprises
a rotatable disk provided with an annular target forming a focal track, which focal track is rotationally symmetric around a symmetry axis; and
a rotor stem for supporting the disk, which stem is rotatably supported around a primary axis of rotation;
wherein the stem is provided with a mounting surface to support the disk;
wherein the disk is provided with an abutment surface to be mounted to the mounting surface;
wherein correction means are arranged between the mounting surface and the abutment surface such that a run-out of the focal track in relation to the axis of rotation is adjustable.

2. X-ray tube according to claim 1, wherein the disk is made of a composite material.

3. X-ray tube according to claim 2, wherein the disk is made of a carbon fiber reinforced carbon composite.

4. X-ray tube according to claim 1, wherein the correction means are arranged such that a deviation between the symmetry axis and the primary axis of rotation is at least partially compensated.

5. X-ray tube according to claim 1, wherein the correction means compensate a radial offset (x) of the symmetry axis in relation to the primary axis of rotation.

6. X-ray tube according to claim 1, wherein the correction means compensate an inclination of the symmetry axis in relation to the primary axis of rotation.

7. X-ray tube according to claim 1, wherein the mounting surface is perpendicular to the primary axis of rotation and wherein the correction means compensate an inclination of the abutment surface in relation to the perpendicular of the symmetry axis.

8. X-ray tube according to claim 1, wherein the corrections means comprise at least one correction shim with a varying thickness providing two outer support surfaces inclined in relation to each other.

9. X-ray tube according to claim 9, wherein two correction shims are provided of which at least one has a varying thickness.

10. X-ray tube according to claim 1, wherein the corrections means are provided with an offset center.

11. X-ray tube according to claim 1, wherein the corrections means comprise a precision machinable bushing affixed to the abutment surface and wherein the bushing is provided with a fitting surface abutting the mounting surface.

12. X-ray tube according to claim 1, wherein the corrections means is made from Niobium.

13. X-ray tube according to claim 1, wherein the run-out of the focal track is eliminated.

14. X-ray imaging system, comprising an X-ray image acquisition device with
a source of X-ray radiation to generate X-ray radiation;
an X-ray image detection module;
a data processing unit connected to the detection module and the radiation source;
a display device; and
an interface unit;
wherein the source of X-ray radiation comprises an X-ray tube according to claim 1.

15. Method for adjusting the run-out of a focal track of an X-ray tube according to claim 1, comprising the steps of:
determining the magnitude for the run-out of the focal track in relation to the rotation axis;
detecting the actual value of the run-out of the focal track;
comparing the actual value with the determined value; and
adapting the correction means thereby adjusting the run-out of the focal track.
